(19) United States
(12) Patent Application Publication
(10) Pub. No.: US 2014/0321461 A1
(43) Pub. Date: Oct. 30, 2014

(54) EFFICIENT CALL ROUTING BASED UPON NETWORK CONDITIONS

(71) Applicant: VONAGE NETWORK LLC, Holmdel, NJ (US)

(72) Inventor: CASEM MAJD, HOLMDEL, NJ (US)

(73) Assignee: VONAGE NETWORK LLC, Holmdel, NJ (US)

(21) Appl. No.: 13/872,852

(22) Filed: Apr. 29, 2013

(51) Int. Cl. H04L 12/721

(52) U.S. Cl. CPC H04L 45/70
USPC 370/389

(57) ABSTRACT

A method and apparatus for routing a telecommunication connection request on an internal telecommunication network are provided herein. In some embodiments, the method may receive a request to establish a telecommunication connection, determine a route to an external telecommunication network to facilitate the establishment of the telecommunication connection based on information associated with the external telecommunication network and internal network conditions of the internal telecommunication network, and route telecommunication network traffic over the internal telecommunication network using the determined route to the external telecommunication network.

### BACKGROUND OF THE INVENTION

1. Field of the Invention

The present invention relates generally to communication systems and, more particularly, to a method and apparatus for routing calls based upon internal network conditions and external telecommunication network information.

2. Description of the Related Art

Voice over IP (VoIP) is a technological development in the field of telecommunications that is utilized to establish and provide voice communications over a data network using the Internet Protocol (IP). Entities (e.g., businesses or individuals) implement VoIP by purchasing and installing the necessary equipment (e.g., one or more Customer Premise Equipment (CPE) devices) and service (i.e., a “high speed” network or broadband connection) to access a VoIP service provider and activating this telecommunication service. Calls from a VoIP subscriber device (i.e., a source) to a destination device (i.e., a sink) may be routed via a number of inter-connected networks, such as via the VoIP service provider network, mobile telephone service provider networks, and existing and traditional telecommunications system more commonly referred to as the Public Switched Telephone Network (PSTN) or Plain Old Telephone Service (POTS).

In a VoIP telecommunication network, for example, a VoIP subscriber may call a destination device of a person not on the VoIP telecommunication network. The generated VoIP telecommunication traffic is handled by a routing engine on the VoIP service provider network that makes routing decisions based on certain criteria to select a route to the destination (i.e., the sink). Specifically, the call may be routed to the destination device via a number of external telecommunication carriers. Routing decisions can be made based on various factors; for example, a primary driver is cost. Thus, when a call request is made, the routing engine will do a look-up to determine the various routes it might pick. The routes may be ordered based on which external telecommunication carrier is cheapest. More advanced systems may take into account quality-of-service (QoS) factors of external telecommunication carriers.

However, the inventor has observed that the basing routing decisions on cost and QoS factors of external telecommunication carriers may not provide adequate quality of service to the subscriber, or may not be possible in certain situations. Accordingly, there exists a need in the art for a method and apparatus for considering additional criteria when routing communication traffic.

### SUMMARY OF THE INVENTION

A method and apparatus for routing a telecommunication connection request on an internal telecommunication network are provided herein. In some embodiments, the method may receive a request to establish a telecommunication connection, determine a route to an external telecommunication network to facilitate the establishment of the telecommunication connection based on information associated with the external telecommunication network and internal network conditions of the internal telecommunication network, and route telecommunication network traffic over the internal telecommunication network using the determined route to the external telecommunication network.

In some embodiments, an apparatus for routing a telecommunication connection request on a internal telecommunication network includes at least one processor, at least one input device, and at least one storage device storing processor executable instructions which, when executed by the at least one processor, performs a method including receiving a request to establish a telecommunication connection, determining a route to an external telecommunication network to facilitate the establishment of the telecommunication connection based on information associated with the external telecommunication network and internal network conditions of internal telecommunication network, and routing telecommunication network traffic over the internal telecommunication network using the determined route to the external telecommunication network.

In some embodiments, a non-transient computer readable medium for storing computer instructions that, when executed by at least one processor causes the at least one processor to perform a method for routing a telecommunication connection request on a internal telecommunication network including receiving a request to establish a telecommunication connection, determining a route to an external telecommunication network to facilitate the establishment of the telecommunication connection based on information associated with the external telecommunication network and internal network conditions of the internal telecommunication network, and routing telecommunication network traffic over the internal telecommunication network using the determined route to the external telecommunication network.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, in accordance with embodiments consistent with the present application;

FIG. 2 depicts a flow diagram of a method for routing calls based upon internal network conditions, according to one or more embodiments of the invention; and

FIG. 3 is a detailed block diagram of a computer system, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention include a method and system for routing calls based upon internal network conditions.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

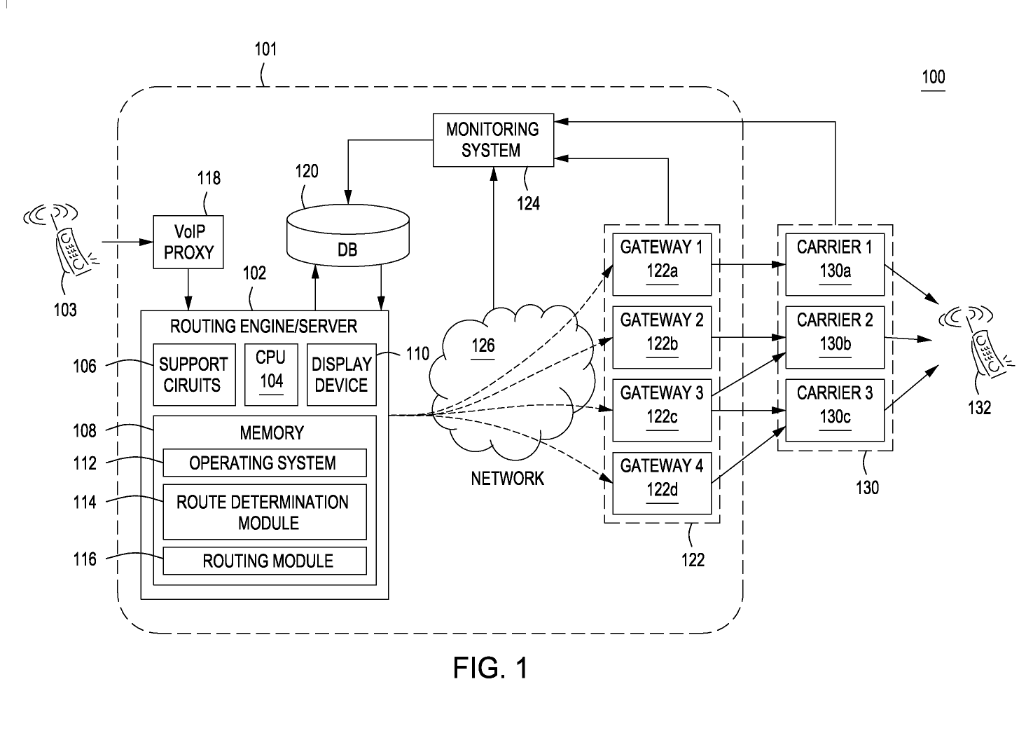

FIG. 1 depicts a block diagram of a system 100 that includes a first telecommunication network 101. The first telecommunication network may be one or more internal telecommunication networks 101 for establishing communications between subscribers of a service provide associated with the one or more internal telecommunication networks and other end users that may also be a subscriber of the service provide associated with the one or more internal telecommunication networks, or that may be subscribers of other service provides. In some embodiments, the internal telecommunication network 101 may be a VoIP network that may facilitate calls between a source device 103, which may be associated with a subscriber of the VoIP network, and destination device 132, which may not be on the VoIP network. Although described in terms of a VoIP network herein, the following description is non-limiting in that it may apply to any type of interconnected telecommunication networks.

In some embodiments, calls initiated using the source device 103 may be routed to destination device 132 via the internal telecommunication network 101 and a second telecommunication network. The second telecommunication network may be any one of a number of external telecommunication networks 130 associated with external service providers/carriers that is able to provide telecommunication service to the destination device 132.

In some embodiments, the internal telecommunication network 101 may include a routing engine 102, a routing information database 120, a network monitoring system 124, an internal network 126, and a plurality of gateways 122 (e.g., 122a-122d) that provide access to external communication networks 130 (e.g., 130a-130c).

In some embodiments, a proxy device 118 provides the source device 103 access to the internal telecommunication network 101. In some embodiments, the proxy device 118 may be a VoIP proxy device.

The routing engine 102 determines the network routes for establishing a telecommunication connection between end user devices (e.g., source device 103 and destination device 132), and routes the telecommunication traffic accordingly. The routing engine 102 comprises a Central Processing Unit (CPU) 104, support circuits 106, memory 108, and, in some embodiments, a display device 110. The CPU 104 may comprise one or more commercially available microprocessors or microcontrollers that facilitate data processing and storage. The various support circuits 106 facilitate the operation of the CPU 104 and include one or more clock circuits, power supplies, cache, input/output circuits, and the like. The memory 108 comprises at least one of Read Only Memory (ROM), Random Access Memory (RAM), disk drive storage, optical storage, removable storage and/or the like. In some embodiments, the memory 108 comprises an operating system 112, route determination module 114, and a routing module 116.

The operating system (OS) 112 generally manages various computer resources (e.g., network resources, file processors, and/or the like). The operating system 112 is configured to execute operations on one or more hardware and/or software modules, such as Network Interface Cards (NICs), hard disks, virtualization layers, firewalls and/or the like. Examples of the operating system 112 may include, but are not limited to, LINUX, MAC OSX, BSD, UNIX, MICROSOFT WINDOWS, 10S, ANDROID and the like.

The routing determination module 114 determines the network routes for establishing a telecommunication connection between end user devices (e.g., source device 103 and destination device 132). Specifically, routing determination module 114 may use information stored in routing information database 120 to determination how to route calls/data. After a route has been determined by routing determination module 114, the routing module 116 uses the determined route to route the call/data accordingly. Although described herein as a routing engine 102 including routing determination module 114 and routing module 116, in some embodiments, these modules may be included on one or more separate devices that communicate with each other.

The route determined by the routing engine 102 includes the internal network route through the internal network 126, a selected gateway from the plurality of gateways 122, and a selected external telecommunication carrier 130 to route the traffic to. The selected external telecommunication carrier 130 would then route the traffic to destination device 132 as appropriate.

The internal network 126 may itself comprise one or more communication systems that connect computers by wire, cable, fiber optic and/or wireless link facilitated by various types of well-known network elements, such as hubs, switches, routers, and the like. The internal network 126 may include an Internet Protocol (IP) network, and may employ various well-known protocols to communicate information amongst the network resources. In addition, although the plurality of gateways 122, and other elements of the internal telecommunication network 101 are shown and discussed separately, these elements may be considered to be part of the internal networks 126.

In some embodiments, the plurality of gateways 122 may be border gateways that connect the internal internal telecommunication network 101 to one or more external telecommunication carriers/networks 130. Each gateway 122a-c may be coupled to one or more external telecommunication carriers/networks 130. For example, gateway 122a is coupled to external telecommunication carrier 130a, and gateway 122c is coupled to both external telecommunication carriers 130b and 130c. The connections shown are non-limiting examples for illustrative purposes.

The routing information database 120 includes information used to determine telecommunication traffic routing. For example, routing information database 120 may include information for each of the external telecommunication carriers 130a-c. The external telecommunication carrier information may include reachability information in form of IP addresses, call transport and termination cost information in form of rate decks, and Quality of Service (QoS) information in form of traffic KPIs (Key Performance Indicators).

There are several categories of KPIs. Some examples of KPIs may include, but are not limited to, call completion KPIs, call quality KPIs, and customer experience KPIs. Some examples of call quality KPIs of the external telecommunications network may include, but are not limited to, packet loss, signal jitter, signal propagation delay, dropped calls, and utilization. Examples for the customer experience KPIs, may include, but are not limited to, an average length of calls (ALOC) and call redial ratio (CRR).

In some embodiments, the KPIs for each external telecommunication carrier 130 may include an Answer to Bid Ratio (ABR) that represents a call completion quality indicator. An ABR is a call completion KPI that represents the Answered Calls divided by Attempted Calls in a given time period. It gives the relationship between the number of bids that result in an answer signal. Another example of a call completion KPI is the Answer to Seizure Ratio (ASR), which represents the Answered Calls divided by voice circuits successfully captured or seized by an external telecommunications network. ASR gives the relationship between the number of seizures that result in an answer signal. Measurement of ASR may be made on a route or on a destination code basis. In some embodiments, typical ABR/ASR values may be about 50%-70%, though sometimes for certain destinations it could go down to 20%. Values above 60% are typically considered good ABR/ASR values.

The rate decks for each external telecommunication carrier is a schedule of costs associated with various dial code prefixes (e.g., Dialed Number Identification Service (DNIS) prefixes) for routing telecommunication traffic or otherwise establishing calls between devices. The cost information may be a per minute charge or a data bandwidth/volume charge associated with using the external telecommunication carrier 130 for completing the route to the destination device 132. For example, the routing engine 102 can expect that if a call is routed to destination device 132 via external telecommunication carrier 130a, it may cost $0.01 per minute and an 80% ABR, while calls routed via carrier 130b may cost $0.02 per minute and an 95% ABR. The routing determination module 114 may use this information to determine the cheapest and/or the most reliable route for routing calls/data.

In some embodiments, the routing information database 120 may include KPI for some or all internal network devices in internal network 126 and the plurality of gateways 122 included in the internal telecommunication network. The KPI for internal network devices may include, but is not limited to, latency, packet loss, jitter, CPU load of a network device. This information may be used by the routing determination module 114 to determine the best internal route through internal network 126 and gateway 122a-c to use. In some embodiments, the internal network KPI may cause the routing determination module 114 to select alternate external carriers 130 to use to complete a call if certain internal gateways 122 are congested or not operating at pre-determined QoS levels.

The KPI information stored in routing information database 120 may include both real time and historical data. The information may include, or otherwise be sorted or grouped by hour, day, monthly, etc. to help determine times of the day that certain network elements experience the most congestion.

In some embodiments, the information stored in database 120 may be obtained from monitoring system 124. The monitoring system pulls information from some or all internal network elements (e.g., internal network 126 elements and each of gateways 122a-d) and each of external telecommunication carriers 130a-c. In some embodiments, the monitoring system 124 can auto-discover network resources, extract operational data, and report the state of the resources in form of a set of KPIs for each network resource discovered. These KPIs are used for display, monitoring, troubleshooting, and analysis of each specific resource. In some embodiments, the monitoring system 124 may provide an interface for receiving the cost (e.g., rates decks) and KPI data from the external telecommunication carriers. In other embodiments, this information may be obtained from the external telecommunication carriers by other means and automatically or manually loaded into routing information database 120.

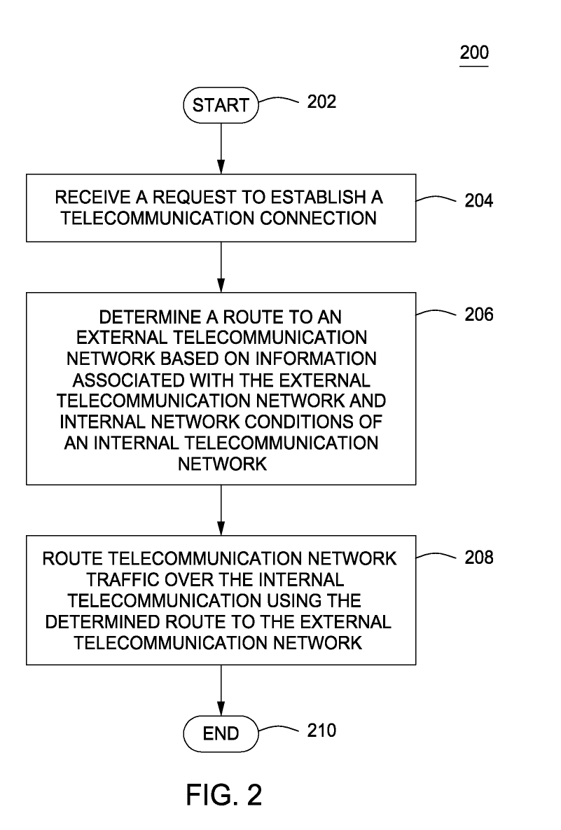

A method 200 in accordance with the subject invention is illustrated in FIG. 2 which depicts a flowchart having a series of steps for determining a telecommunication network route on an internal telecommunication network. In detail, the method 200 starts at 202 and proceeds to 204 where a request to establish a telecommunication connection is received. In some embodiments, the request may be received by the routing engine 102 from a source device (via proxy 118 for example) attempting to establish a telecommunication connection with a sink or destination device. For example, source device 103 may be a VoIP source device associated with a subscriber of a VoIP telecommunication network (e.g., an internal telecommunication network) and may wish to establish a telecommunication connection with destination device 132 that is not on the VoIP telecommunication network.

Since destination device 132 is not on the VoIP telecommunication network, the routing engine 102 determines a set of potential external telecommunication networks (e.g., external telecommunication networks 130a-c) that may be used to facilitate the establishment of the requested telecommunication connection (e.g., provide the final leg of the call). At 206, the routing engine 102 may determine a route to an external telecommunication network (e.g., 130a-c) to facilitate the establishment of the telecommunication connection. In some embodiments, the determination of the route to an external telecommunication network 130 may be based on information associated with the external telecommunication network and internal network conditions of the internal telecommunication network.

The information associated with the external telecommunication network may include a cost for using the external telecommunication network and quality of service metrics associated the external telecommunication network, as discussed above. Meanwhile, the internal network conditions of the internal telecommunication network includes KPI of one or more networking devices on the internal telecommunication network, such as latency, jitter, packet loss, and the like. In some embodiments, internal network conditions may also include a cost of using various internal network devices that may also be factored into the determination of any routes selected.

In some embodiments, determining the route to an external telecommunication network may include determining a set of routes to a plurality of external telecommunication networks capable of establishing the telecommunication connection based on information associated with each of the plurality of external telecommunication networks, and then selecting a route from the determined set of routes based on internal network conditions. For example, after receiving the request to establish a telecommunication connection to destination device 132, the routing engine 102 may determine a set of all the external telecommunication networks capable of terminating the telecommunication connection to destination device 132, and determine route to each of those external telecommunication networks. The routing engine 102 may then obtain a first subset of external telecommunication networks (and routes thereto) by filtering and/or ranking the set of external telecommunication networks using information associated with each of the plurality of external telecommunication networks (e.g., cost and KPI/QoS information). The routing engine 102 may then filter and/or rank that first subset of external telecommunication networks to obtain a second subset of external telecommunication networks (and routes thereto) based on internal network conditions of the internal telecommunication network.

Using the approach described above, an external telecommunication network that may have the most desirable cost and KPI, or ratios thereof, may not be selected due to internal network conditions. For example, external telecommunication carrier 130a provides both the lowest cost of use and best QoS for terminating a call to destination device 132 and may be ranked first based on external telecommunication network information alone. However, routing engine 102 may determine that internal networks conditions at gateway 122a are providing packet losses that exceed a threshold level causing poor QoS. Therefore, routing engine 102 may determine that external telecommunication carrier 130b via gateway 122c provides the best route and selects that one.

After the route to a selected external telecommunication network is determined, the telecommunication network traffic between the source device and the destination device is routed over the internal telecommunication network using the determined route to the selected external telecommunication network at 208.

In other embodiments, the information collected by the monitoring system 124 and stored in routing information database 120 may be used to determine bottlenecks in the internal telecommunication network 101. In further embodiments, the difference in costs between selecting an external telecommunication network at 208 other than the highest ranked external telecommunication network may be determined by the monitoring system 124, the routing engine 102, or another device. These costs may be used to help determine where the internal telecommunication network 101 should allocate additional resources or upgrade network equipment.

The method 200 ends at 210.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

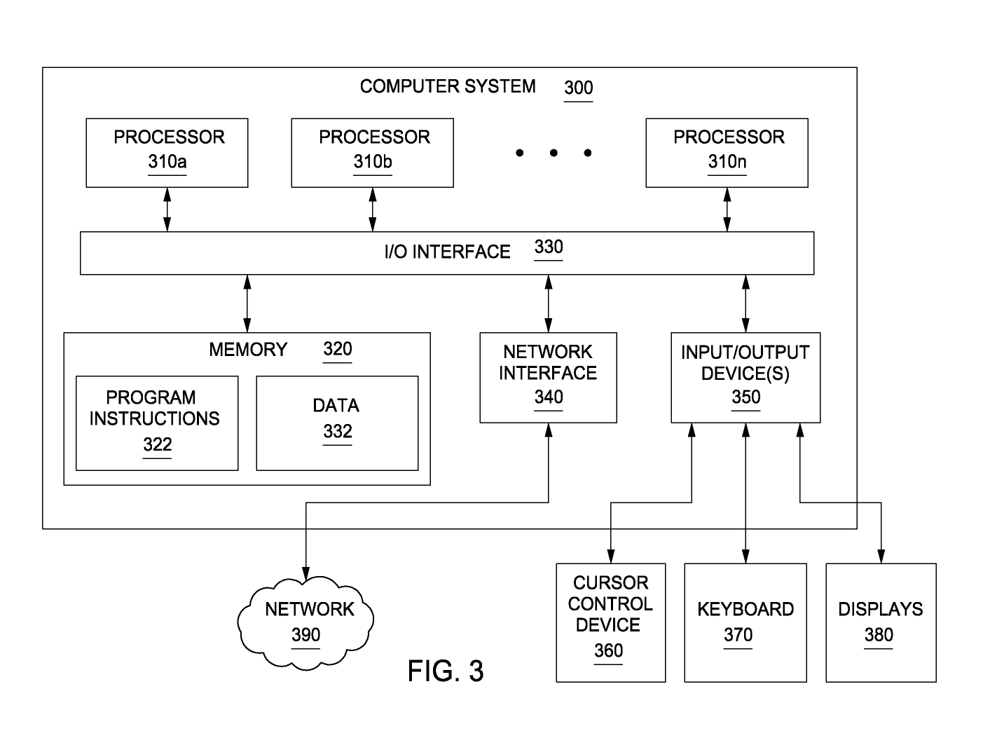

FIG. 3 depicts a computer system 300 that can be utilized in various embodiments of the present invention to implement the computer and/or the display, according to one or more embodiments.

Various embodiments of method and apparatus for routing calls based upon internal network conditions and/or external carrier network information, as described herein, may be executed on one or more computer systems, which may interact with various other devices. One such computer system is computer system 300 illustrated by FIG. 3, which may in various embodiments implement any of the elements or functionality illustrated in FIGS. 1-2. In various embodiments, computer system 300 may be configured to implement methods described above. The computer system 300 may be used to implement any other system, device, element, functionality or method of the above-described embodiments. In the illustrated embodiments, computer system 300 may be configured to implement method 200 as processor-executable executable program instructions 322 (e.g., program instructions executable by processor(s) 310) in various embodiments.

In the illustrated embodiment, computer system 300 includes one or more processors 310a-310n coupled to a system memory 320 via an input/output (I/O) interface 330. Computer system 300 further includes a network interface 340 coupled to I/O interface 330, and one or more input/output devices 350, such as cursor control device 360, keyboard 370, and display(s) 380. In various embodiments, any of the components may be utilized by the system to receive user input described above. In various embodiments, a user interface may be generated and displayed on display 380. In some cases, it is contemplated that embodiments may be implemented using a single instance of computer system 300, while in other embodiments multiple such systems, or multiple nodes making up computer system 300, may be configured to host different portions or instances of various embodiments. For example, in one embodiment some elements may be implemented via one or more nodes of computer system 300 that are distinct from those nodes implementing other elements. In another example, multiple nodes may implement computer system 300 in a distributed manner.

In different embodiments, computer system 300 may be any of various types of devices, including, but not limited to, personal computer systems, mainframe computer systems, handheld computers, workstations, network computers, application servers, storage devices, a peripheral devices such as a switch, modem, router, or in general any type of computing or electronic device.

In various embodiments, computer system 300 may be a uniprocessor system including one processor 310, or a multiprocessor system including several processors 310 (e.g., two, four, eight, or another suitable number). Processors 310 may be any suitable processor capable of executing instructions. For example, in various embodiments processors 310 may be general-purpose or embedded processors implementing any of a variety of instruction set architectures (ISAs). In multiprocessor systems, each of processors 310 may commonly, but not necessarily, implement the same ISA.

System memory 320 may be configured to store program instructions 322 and/or data 332 accessible by processor 310. In various embodiments, system memory 320 may be implemented using any suitable memory technology, such as static random access memory (SRAM), synchronous dynamic RAM (SDRAM), non-volatile/Flash-type memory, or any other type of memory. In the illustrated embodiment, program instructions and data implementing any of the elements of the embodiments described above may be stored within system memory 320. In other embodiments, program instructions and/or data may be received, sent or stored upon different types of computer-accessible media or on similar media separate from system memory 320 or computer system 300.

In one embodiment, I/O interface 330 may be configured to coordinate I/O traffic between processor 310, system memory 320, and any peripheral devices in the device, including network interface 340 or other peripheral interfaces, such as input/output devices 350. In some embodiments, I/O interface 330 may perform any necessary protocol, timing or other data transformations to convert data signals from one component (e.g., system memory 320) into a format suitable for use by another component (e.g., processor 310). In some embodiments, I/O interface 330 may include support for devices attached through various types of peripheral buses, such as a variant of the Peripheral Component Interconnect (PCI) bus standard or the Universal Serial Bus (USB) standard, for example. In some embodiments, the function of I/O interface 330 may be split into two or more separate components, such as a north bridge and a south bridge, for example. Also, in some embodiments some or all of the functionality of I/O interface 330, such as an interface to system memory 320, may be incorporated directly into processor 310.

Network interface 340 may be configured to allow data to be exchanged between computer system 300 and other devices attached to a network (e.g., network 390), such as one or more external systems or between nodes of computer system 300. In various embodiments, network 390 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 340 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 350 may, in some embodiments, include one or more display terminals, keyboards, keypads, touchpads, scanning devices, voice or optical recognition devices, or any other devices suitable for entering or accessing data by one or more computer systems 300. Multiple input/output devices 350 may be present in computer system 300 or may be distributed on various nodes of computer system 300. In some embodiments, similar input/output devices may be separate from computer system 300 and may interact with one or more nodes of computer system 300 through a wired or wireless connection, such as over network interface 340.

In some embodiments, the illustrated computer system may implement any of the methods described above, such as the methods illustrated by the flowchart of FIG. 2. In other embodiments, different elements and data may be included.

Those skilled in the art will appreciate that computer system 300 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 300 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 300 may be transmitted to computer system 300 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for routing a telecommunication connection request on an internal telecommunication network comprising:
receiving the request to establish a telecommunication connection;
determining a route to an external telecommunication network to facilitate the establishment of the telecommunication connection based on information associated with the external telecommunication network and network conditions of the internal telecommunication network; and
routing telecommunication network traffic over the internal telecommunication network using the determined route to the external telecommunication network.

2. The method of claim 1, wherein the network conditions of the first internal telecommunication network includes key performance indicators (KPI) of one or more networking devices on the first internal telecommunication network.

3. The method of claim 2, wherein the KPI of the one or more networking devices on the first internal telecommunication network include at least one of latency, jitter, packet loss, call drops, or utilization.

4. The method of claim 1, wherein the information associated with the external telecommunication network includes a cost for using the external telecommunication network and quality of service metrics associated the external telecommunication network.

5. The method of claim 1, wherein determining the route to the external telecommunication network includes:
determining a set of routes to a plurality of external telecommunication networks capable of establishing the telecommunication connection based on information associated with each of the plurality of external telecommunication networks; and
selecting a route from the determined set of routes based on internal network conditions.

6. The method of claim 5, wherein the information associated with the external telecommunication network includes a cost for using the external telecommunication network and quality of service metrics associated the external telecommunication network.

7. The method of claim 5, wherein the determined set of routes to the plurality of external telecommunication networks are ranked based on at least one of cost or quality of service metrics.

8. The method of claim 7, wherein a route to an external telecommunication network that is different than the route with a highest rank is selected based on internal network conditions.

9. The method of claim 1, wherein the information associated with the external telecommunication network and the internal network conditions of the first internal telecommunication network are stored in a database maintained by the internal telecommunication network.

10. The method of claim 1, wherein the information associated with the external telecommunication network and the internal network conditions of the internal telecommunication network are obtained via a monitoring system included in the internal telecommunication network.

11. An apparatus for determining routing a telecommunication connection request on a internal telecommunication network comprising:
a) at least one processor;
b) at least one input device; and
c) at least one storage device storing processor-executable instructions which, when executed by the at least one processor, performs a method including
1) receiving a request to establish a telecommunication connection;
2) determining a route to an external telecommunication network to facilitate the establishment of the telecommunication connection based on information associated with the external telecommunication network and network conditions of the internal telecommunication network; and
3) routing telecommunication network traffic over the internal telecommunication network using the determined route to the external telecommunication network.

12. The apparatus of claim 11, wherein the network conditions of the internal telecommunication network includes key performance indicators (KPI) of one or more networking devices on the internal telecommunication network.

13. The apparatus of claim 12, wherein the KPI of the one or more networking devices on the internal telecommunication network include at least one of latency, jitter, packet loss, call drops, or utilization.

14. The apparatus of claim 11, wherein the information associated with the external telecommunication network includes a cost for using the external telecommunication network and quality of service metrics associated the external telecommunication network.

15. The apparatus of claim 11, wherein determining the route to the external telecommunication network includes:
determining a set of routes to a plurality of external telecommunication networks capable of establishing the telecommunication connection based on information associated with each of the plurality of external telecommunication networks; and
selecting a route from the determined set of routes based on internal network conditions.

16. The apparatus of claim 15, wherein the information associated with the external telecommunication network includes a cost for using the external telecommunication network and quality of service metrics associated the external telecommunication network.

17. The apparatus of claim 15, wherein the determined set of routes to the plurality of external telecommunication networks are ranked based on at least one of cost or quality of service metrics.

18. The apparatus of claim 17 wherein a route to an external telecommunication network that is different than the route with a highest rank is selected based on internal network conditions.

19. The apparatus of claim 11, wherein the information associated with the external telecommunication network and the internal network conditions of the internal telecommunication network are stored in a database maintained by the internal telecommunication network.

20. A non-transient computer readable medium for storing computer instructions that, when executed by at least one processor causes the at least one processor to perform a method for routing a telecommunication connection request on a internal telecommunication, comprising:
receiving the request to establish a telecommunication connection;
determining a route to an external telecommunication network to facilitate the establishment of the telecommunication connection based on information associated with the external telecommunication network and network conditions of the internal telecommunication network; and
routing telecommunication network traffic over the first internal telecommunication network using the determined route to the external telecommunication network.
